(19) United States
(12) Patent Application Publication
(10) Pub. No.: US 2022/0117445 A1
(43) Pub. Date: Apr. 21, 2022

(54) FOLDABLE AND DISPLACEABLE BATHING CHAIR STRUCTURE

(71) Applicant: Han LIN, Tainan (TW)

(72) Inventor: Han LIN, Tainan (TW)

(21) Appl. No.: 17/072,796

(22) Filed: Oct. 16, 2020

(51) Int. Cl. A47K 3/12; A61G 7/10

(52) U.S. Cl. CPC A47K 3/122; A61G 7/1034; A61G 2200/34; A61G 7/1074; A61G 7/1076; A61G 7/1059

(57) ABSTRACT

A foldable and displaceable bathing chair structure comprises a seat unit and a seat supporting unit. The seat unit comprises a movable cushion and at least two sliding components. Each sliding component comprises at least one roller and a seat positioning piece. The seat supporting unit comprises four folding units, four chair legs, two side pipe bodies and two cushion pipe bodies. Each folding unit comprises a first connecting part connected with the chair leg, a second connecting part connected with the side pipe body and a third connecting part connected with the cushion pipe body. Each cushion pipe body includes at least one seat positioning hole, and each side pipe body includes a folding switch component. The roller of each sliding component drives the movable cushion to move thereon. The folding switch components enable the chair legs to be displaced relative to the cushion pipe bodies.

### FIELD OF THE INVENTION

The invention relates to a foldable and displaceable bathing chair structure, in particular to a folding and conveniently displaceable bathing chair structure.

### BACKGROUND OF THE INVENTION

In recent years, a bathing chair is often used for assisting the old people or people disabled in action in bathing or showering. Most of the existing designs are directly fixedly connected with a chair body with a backrest by a pipe component, so that the designed bathing chair usually occupies a certain volume and has the defect that it is not easy to store.

Meanwhile, when the conventional bathing chair is moved during the bathing, it is usually laborious, time-consuming and difficult for a caregiver who cares for a disabled person to bath. It is easy for the disabled person to be in a dangerous situation, so that it is an object of the present invention to improve how the conventional bathing chair can be easily moved during the bathing and stored after use.

### SUMMARY OF THE INVENTION

The purpose of the invention is to provide a foldable and displaceable bathing chair structure, which enables a user to conveniently move in the bathing process and conveniently store the chair after use, so that the convenience of operation and the safety of use are improved, and the problems of the conventional bathing chair are solved.

To achieve the above purpose, the invention provides a foldable and displaceable bathing chair structure, which comprises a seat unit and a seat supporting unit. The seat unit comprises a movable cushion and at least two sliding components arranged below the movable cushion, wherein each of the sliding component includes at least one roller, and at least one of the sliding components includes a seat positioning piece, two sliding connecting pieces pivotally connected on the seat positioning piece, two connecting wire bodies respectively connected to one end of one of the two sliding connecting pieces, and a sliding return spring pivotally connected on the seat positioning piece. The seat supporting unit comprises four folding units, four chair legs, two side pipe bodies and two cushion pipe bodies, wherein each of the four folding units comprises a first connecting part connected with one of the four chair legs, a second connecting part connected with one of the two side pipe bodies and a third connecting part connected with one of the two cushion pipe bodies, and wherein each of the two cushion pipe bodies includes at least one seat positioning hole, and each of the two side pipe bodies includes a folding switch component. Each of the two cushion pipe bodies is provided with one of the sliding components, the roller of each sliding component drive the movable cushion to move on the cushion pipe bodies, and the seat positioning hole provides the seat positioning piece to position and fix the movable cushion; and the folding switch components enable the chair legs connected with the first connecting parts of the folding units to be displaced relative to the cushion pipe bodies.

Further, each of the four folding units comprises a first pivoting unit including the first connecting part and the second connecting part, and a second pivoting unit including the third connecting part; the first pivoting unit includes a first pivoting hole arranged at one end opposite to the first connecting part, and the second connecting part is positioned between the first connecting part and the first pivoting hole and protrudes outwards from a periphery of the first pivoting unit to form a pipe body for accommodating one of the two side pipe bodies; and the second pivoting unit includes a second pivoting hole where is corresponding to the first pivoting hole, and a pivoting piece penetrates through the first pivoting hole and the second pivoting hole to enable the first pivoting unit to rotate relative to the second pivoting unit.

Further, the second connecting part of two of the four folding units comprises a fixed pin sliding slot, a fixed pin accommodated in the fixed pin sliding slot, and a fixed pin return spring; and a pivoting surface of the second pivoting unit facing the first pivoting unit comprises at least one folding positioning hole, wherein the fixed pin penetrates through the first pivoting unit and one end of the fixed pin is positioned in at least one folding positioning hole, and the other end of the fixed pin is connected with a fixed pin linkage piece to link with the folding switch component connected with the other end of the fixed pin linkage piece.

Furthermore, each of the two side pipe bodies further comprises a side pipe body groove and a folding switch cover body covering the side pipe body groove, the folding switch component comprises a switch abutting part accommodated in each of the two side pipe bodies to penetrate through and limit the folding switch cover body, and one end of the switch abutting part is connected with the fixed pin linkage piece.

Further, one end of each cushion pipe body connected to the third connecting part includes a cushion pipe body positioner, and the third connecting part includes at least one cushion pipe body positioning hole, wherein the cushion pipe body positioning hole accommodates the cushion pipe body positioner.

Furthermore, at least one chair leg positioning hole is arranged at one end of each of the four chair legs connected to the first connecting part, and a chair leg positioner is arranged at the first connecting part correspondingly, wherein one of the chair leg positioning holes provides for accommodating the chair leg positioner therein.

Furthermore, one side of the seat unit includes a sliding control switch, and each sliding control switch is separately connected with the other end of one of the two sliding connecting pieces and controls the seat positioning piece pivotally connected at the sliding connecting piece to be disengaged from the seat positioning hole.

Further, the seat unit comprises a bendable backrest component and two detachable auxiliary side grips, and the bendable backrest component comprises a backrest and at least one backrest control switch, which controls the backrest to be bent relative to the movable cushion.

Further, the backrest control switch comprises a first positioning backrest pivoting piece with two first limiting slots, a backrest positioning piece with two backrest limiting blocks, a second positioning backrest pivoting piece with at least three second limiting slots, and a backrest control switch pivoting piece, and wherein the backrest positioning piece further includes a backrest positioning chamber for accommodating a backrest return spring, and the two backrest limiting blocks are accommodated in the two first limiting slots and two of the second limiting slots.

Furthermore, a seat rotating unit is provided between the movable cushion and the sliding components, the seat rotating unit comprising: a first plate body, a positioner arranged on the first plate body, a pivoting shaft arranged on the first plate body and positioned in the positioner, and a limiting fixer arranged on the first plate body and positioned on a periphery of the positioner, wherein the pivoting shaft is pivotally connected between the movable cushion and the first plate body, and the positioner includes a plurality of accommodating slots, a plurality of ball bearings and a plurality of rotary positioning holes; each of the plurality of accommodating slots accommodates one of the ball bearings, the plurality of ball bearings abuts the movable cushion, and the plurality of rotary positioning holes are arranged on the positioner; and the limiting fixer includes a limit rod, a group of return springs arranged on the limit rod, a group of limit rod connecting pieces arranged on the limit rod and sleeved in the group of return spring, and a limit fixing piece, wherein the limit fixing piece accommodates in the positioner and limits the limit rod, the return spring and the limit rod connecting piece, and each limit rod connecting piece is inserted into each rotary positioning hole.

In order to achieve the above and other purposes, the foldable and displaceable bathing chair structure of the present invention adopts the technical features, the components and the effects thereof to be described as follows by a preferred embodiment.

### BRIEF DESCRIPTION OF THE DRAWINGS

FIG. 1 is a three-dimensional combined schematic view of the foldable and displaceable bathing chair structure of the invention.

FIG. 2 is a schematic view of the foldable and displaceable bathing chair structure of the present invention in a folded state.

FIG. 3 is a schematic view showing the foldable and displaceable bathing chair structure according to the present invention in a folded state from another perspective.

FIG. 4 is a partially exploded schematic view of a folding unit of the foldable and displaceable bathing chair structure of the present invention.

FIGS. 5 to 7 are action schematic views for folding the folding unit of the foldable and displaceable bathing chair structure of the invention.

FIG. 8 is an exploded schematic view of a sliding component of the foldable and displaceable bathing chair structure of the present invention.

FIGS. 9 to 14 are action schematic views for displacing a seat unit of the foldable and displaceable bathing chair structure of the present invention.

FIG. 15 is a partially exploded schematic view of the seat unit of the foldable and displaceable bathing chair structure of the present invention.

FIGS. 16 to 18 are sectional action schematic views of a backrest control switch of the foldable and displaceable bathing chair structure of the present invention.

FIGS. 19 to 21 are side action schematic views of the backrest control switch of the foldable and displaceable bathing chair structure of the present invention.

FIG. 22 is a partially exploded schematic view of a seat rotating unit of the foldable and displaceable bathing chair structure according to another embodiment of the present invention.

FIGS. 23 to 25 are schematic views showing rotating and fixing actions of the seat rotating unit according to another embodiment of the present invention.

### DETAILED DESCRIPTION OF THE PREFERRED EMBODIMENTS

The present invention provides a foldable and displaceable bathing chair structure, which comprises a seat unit 10 and a seat supporting unit 20.

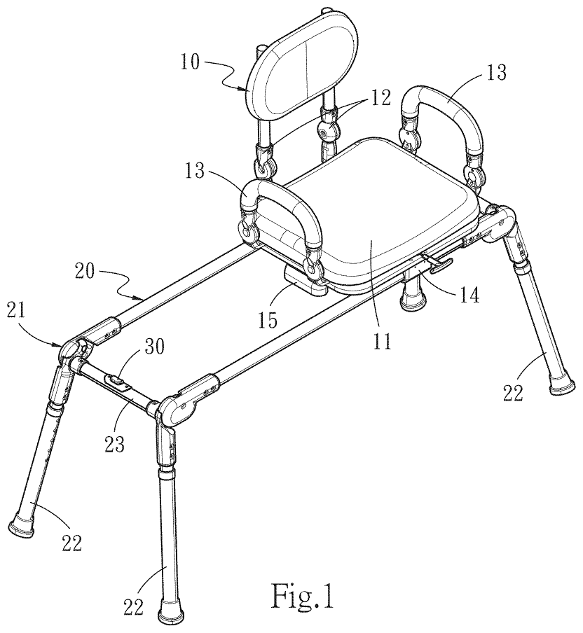

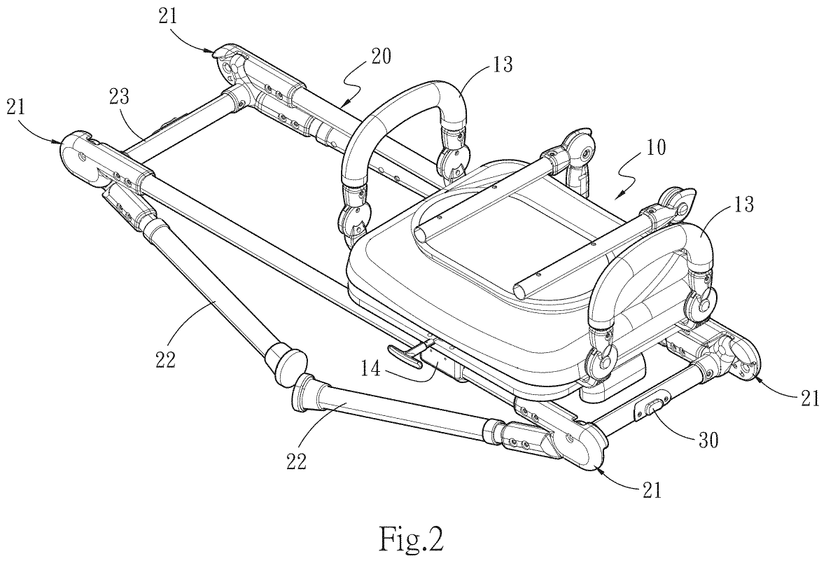

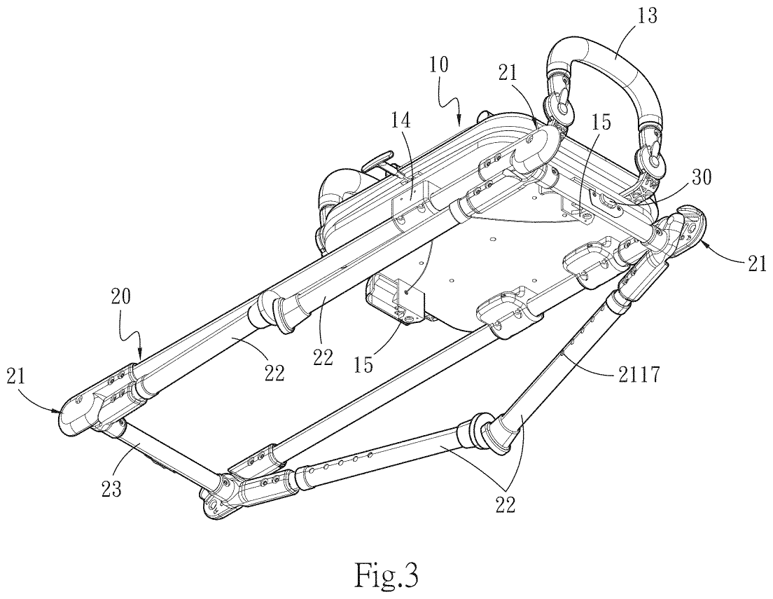

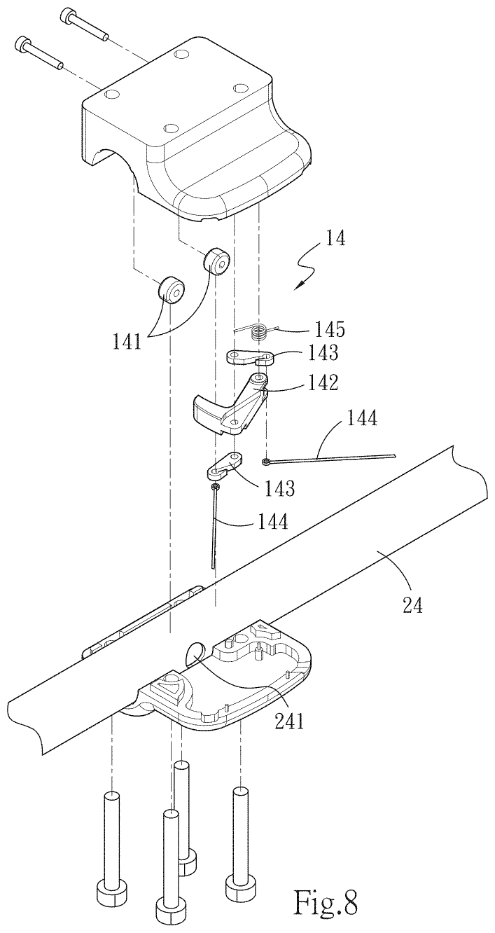

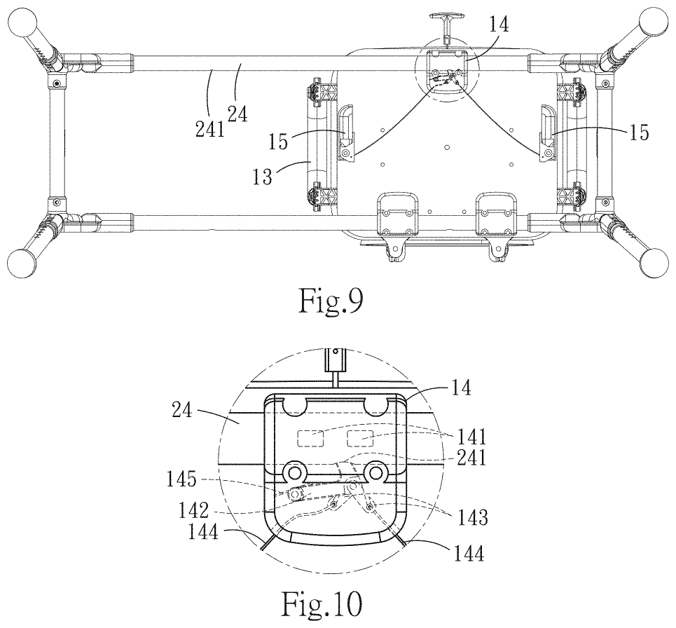

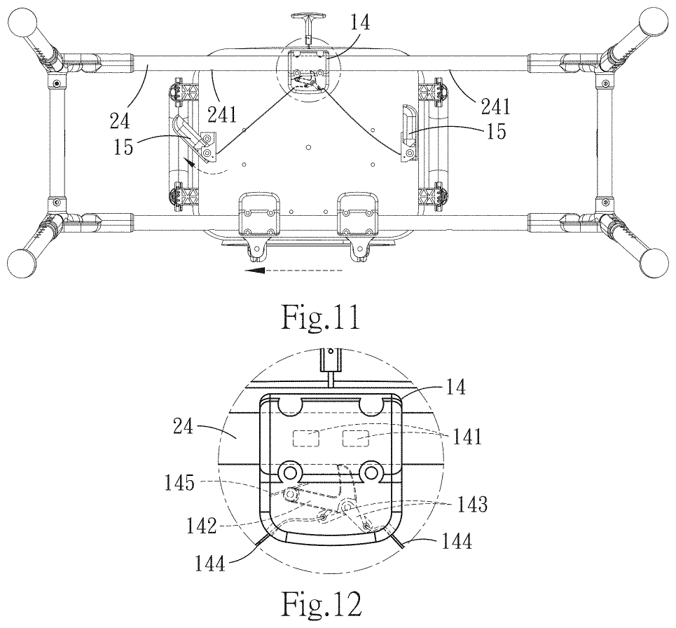

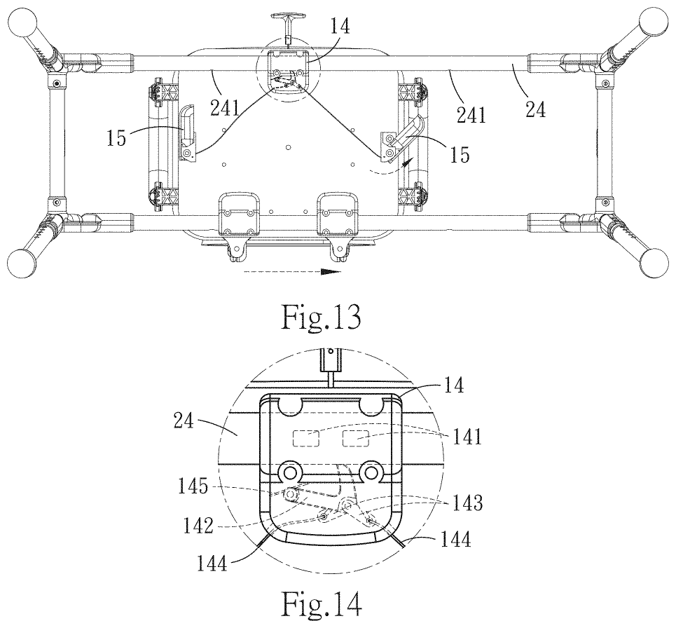

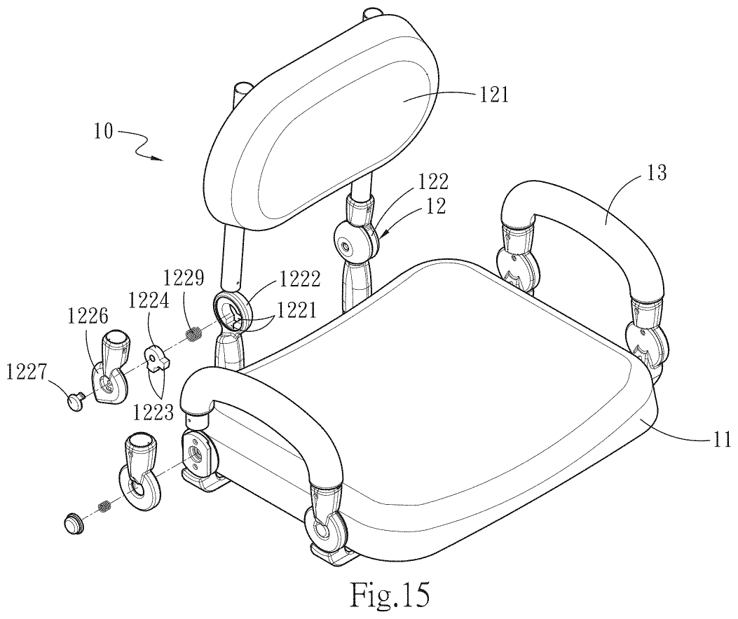

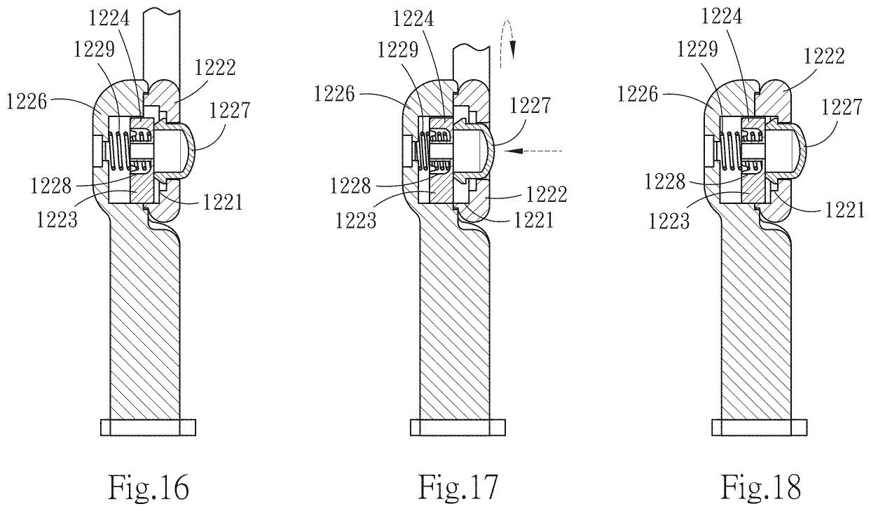

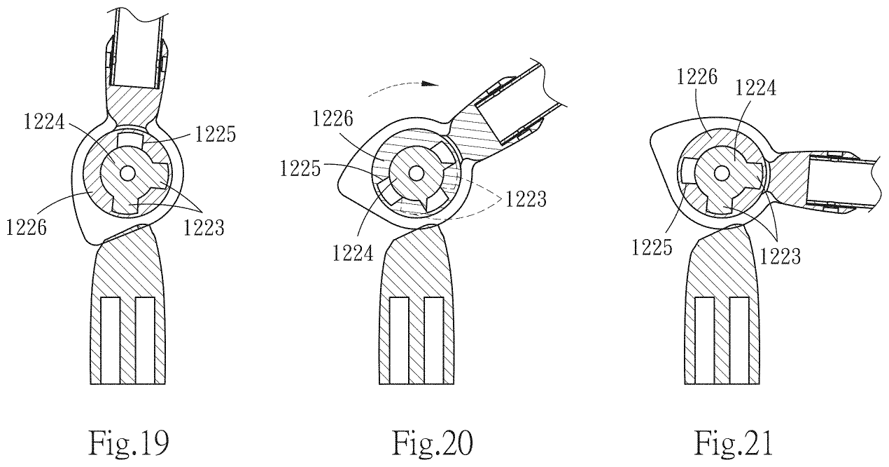

As shown in FIG. 1, FIG. 2, FIG. 3 and FIG. 15, the seat unit 10 comprises a movable cushion 11, two foldable backrest components 12, two detachable auxiliary side grips 13, and three sliding components 14 arranged below the movable cushion 11. As shown in FIG. 8, each of the three sliding components 14 includes a sliding upper cover and a sliding lower cover, four screws for fixing the sliding upper cover and the sliding lower cover, and two rollers 141. At least one of the three sliding components 14 includes a seat positioning piece 142, two sliding connecting pieces 143 and two connecting wire bodies 144. The two sliding connecting pieces 143 are pivotally connected to the seat positioning piece 142, and one end of the seat positioning piece 142 is pivotally connected with a sliding return spring 145 which abuts at least one of the sliding upper cover or the sliding lower cover, and one end of two connecting wire bodies 144 is connected with the two sliding connecting pieces 143, respectively. Referring to FIG. 9, FIG. 10, FIG. 11, FIG. 12, FIG. 13 and FIG. 14, two sliding control switches 15 separately positioned below the two detachable auxiliary side grips 13 are provided at two sides of the seat unit 10. The two sliding control switches 15 control the two sliding connecting pieces 143 and drive the seat positioning piece 142 to move by respectively connecting with the other end of the two connecting wire bodies 144. Referring to FIG. 9, FIG. 10, FIG. 11 and FIG. 12, the two sliding control switches 15 control the seat unit 10 to be movable toward left or right sides in an unlocked state. Instead, the two sliding control switches 15 control the seat unit 10 to be unmovable in a locked state, as shown in FIG. 13 and FIG. 14. Referring to FIG. 15, FIG. 16, FIG. 17, FIG. 18, FIG. 19, FIG. 20 and FIG. 21, the seat unit 10 is pivotally with the two foldable backrest components 12 which respectively comprise a backrest 121 and a backrest control switch 122. The backrest control switch 122 controls the backrest 121 to be bent relative to the movable cushion 11. The backrest control switch 122 comprises a first positioning backrest pivoting piece 1222 with two first limiting slots 1221, a backrest positioning piece 1224 with two backrest limiting blocks 1223, a second positioning backrest pivoting piece 1226 with at least three second limiting slots 1225, and a backrest control switch pivoting piece 1227. Referring to FIG. 16, FIG. 17, FIG. 18, FIG. 19, FIG. 20 and FIG. 21, the backrest positioning piece 1224 further includes a backrest positioning chamber 1228 for accommodating a backrest return spring 1229. The two backrest limiting blocks 1223 are accommodated in the two first limiting slots 1221; and the two backrest limiting blocks 1223 are accommodated in two of the three second limiting slots 1225. After a user presses the backrest control switch 122, the backrest 121 moves toward the movable cushion 11 through the first positioning backrest pivoting piece 1222, and the backrest return spring 1229 returns to original state after the backrest 121 is bent to a predetermined position.

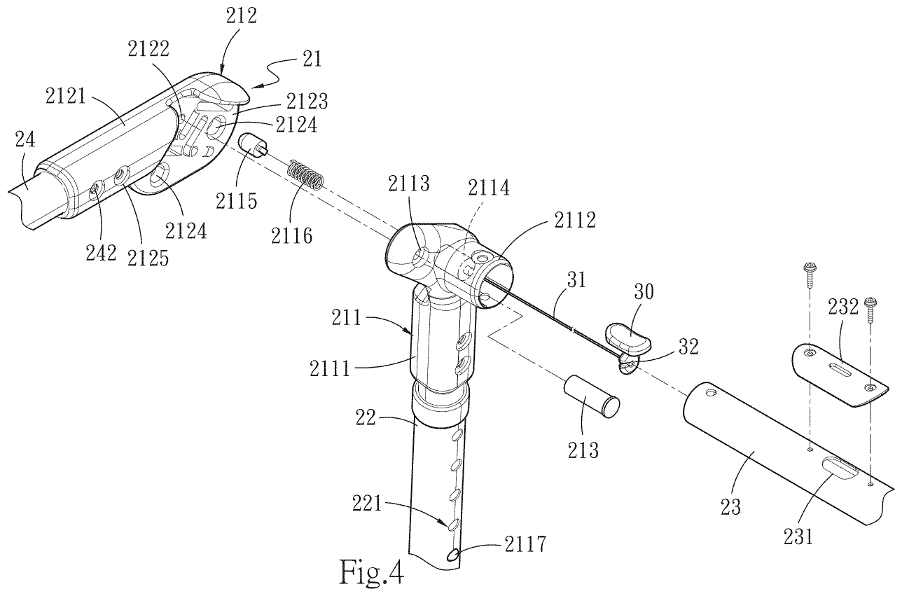

Referring to FIG. 1, FIG. 2, FIG. 3 and FIG. 4, the seat supporting unit 20 comprises four folding units 21, four chair legs 22, two side pipe bodies 23 and two cushion pipe bodies 24. Each of the four folding units 21 comprises a first pivoting unit 211 and a second pivoting unit 212 pivotally connected thereto. The first pivoting unit 211 includes a first connecting part 2111 connected with one of the four chair legs 22, a second connecting part 2112 connected with one of the two side pipe bodies 23, and a first pivoting hole 2113 arranged at one end opposite to the first connecting part 2111. In detail, the second connecting part 2112 is positioned between the first connecting part 2111 and the first pivoting hole 2113 and protrudes outwards from a periphery of the first pivoting unit 211 to form a pipe body for accommodating one of the two side pipe bodies 23. One end of the second pivoting unit 212 connected to one of the two cushion pipe bodies 24 comprises a third connecting part 2121, and the second pivoting unit 212 includes a second pivoting hole 2122 where is corresponding to the first pivoting hole 2113. A pivoting piece 213 penetrates through the first pivoting hole 2113 and the second pivoting hole 2122 to enable the first pivoting unit 211 to rotate relative to the second pivoting unit 212. Each of the two cushion pipe bodies 24 comprises at least one seat positioning hole 241, and each of the two side pipe bodies 23 comprises a folding switch component 30. The second connecting part 2112 of two of the four folding units 21 comprises a fixed pin sliding slot 2114, a fixed pin 2115 accommodated in the fixed pin sliding slot 2114, and a fixed pin return spring 2116 abutted one end of the fixed pin 2115. A pivoting surface 2123 of the second pivoting unit 212 facing the first pivoting unit 211 is provided with two folding positioning holes 2124, wherein the fixed pin 2115 penetrates through the first pivoting unit 211, and one end of the fixed pin 2115 is positioned in one of the two folding positioning holes 2124, and the other end of the fixed pin 2115 is connected with a fixed pin linkage piece 31 to link with the folding switch component 30 connected with the other end of the fixed pin linkage piece 31. In this embodiment, the fixed pin 2115 is only provided in one of the two folding units 21, which are respectively located at two ends of one side pipe body 23, but not limited thereto.

In addition, each of the two side pipe bodies 23 further comprises a side pipe body groove 231 and a folding switch cover body 232 covering the side pipe body groove 231. The folding switch component 30 comprises a switch abutting part 32 accommodated in each of the two side pipe bodies 23 to penetrate through and limit the folding switch cover body 232, and one end of the switch abutting part 32 is connected with the fixed pin linkage piece 31.

Also, as shown in FIG. 4, one end of each of the two cushion pipe bodies 24 connected to the third connecting part 2121 includes two cushion pipe body positioners 242, and the third connecting part 2121 includes two cushion pipe body positioning holes 2125. The two cushion pipe body positioning holes 2125 accommodate the two cushion pipe body positioners 242, respectively.

Furthermore, a plurality of chair leg positioning holes 221 are provided at one end of each of the four chair legs 22 connected to the first connecting part 2111; and a chair leg positioner 2117 is provided at the first connecting part 2111 correspondingly. Specifically, one of the chair leg positioning holes 221 is provided for accommodating the chair leg positioner 2117 therein, so that each of the four chair legs 22 is connected and fixed to the first connecting part 2111 of the first pivoting unit 211.

As shown in FIG. 9, FIG. 10, FIG. 11, FIG. 12, FIG. 13 and FIG. 14, the two cushion pipe bodies 24 comprise the three sliding components 14. Each sliding control switch 15 controls the seat positioning piece 142 at the other end of the sliding connecting piece 143 to be disengaged from the seat positioning hole 241, so that the two rollers 141 of each of the three sliding components 14 drive the movable cushion 11 moving to the seat positioning hole 241 on the two cushion pipe bodies 24. The seat positioning piece 142 automatically returns to original state to be positioned and fixed in the seat positioning hole 241 so as to fix the movable cushion 11.

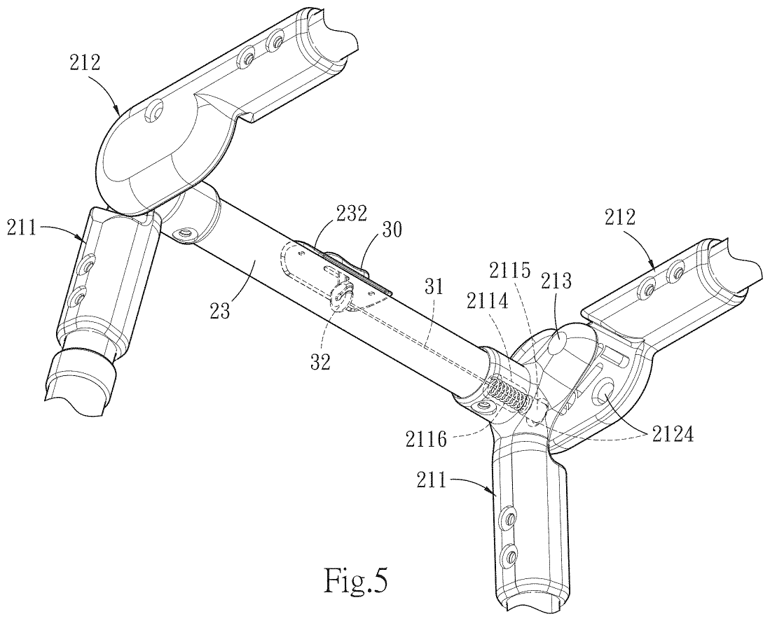

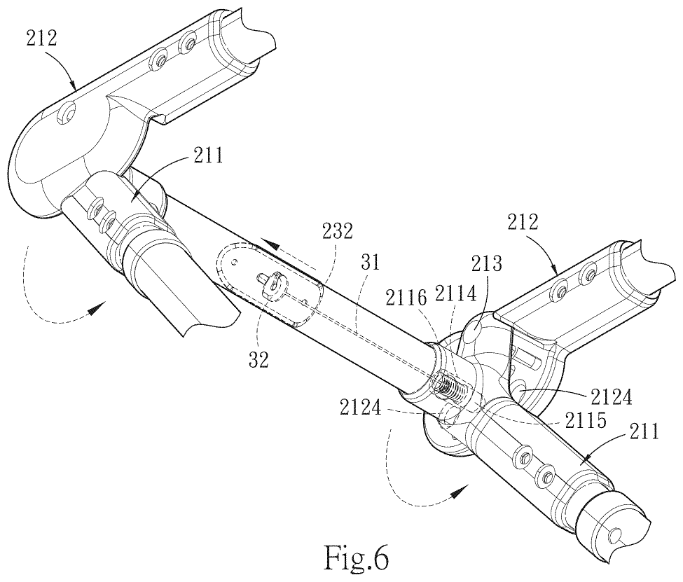

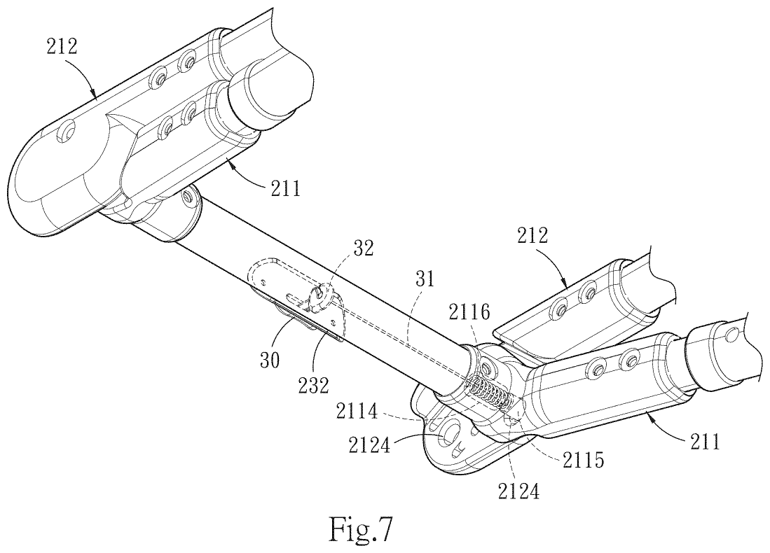

Referring again to FIG. 2, FIG. 3, FIG. 5, FIG. 6 and FIG. 7, the folding switch component 30 controls the four chair legs 22 displacing relative to the cushion pipe body 24. Further, when the user slides the folding switch component 30, the switch abutting part 32 drives the fixed pin linkage piece 31 to force the fixed pin 2115. Thus, the fixed pin 2115 compresses the fixed pin return spring 2116 in the fixed pin sliding slot 2114 and disengages from the folding positioning hole 2124, so that the user is able to fold the four chair legs 22 or unfold the four chair legs 22 according to requirements, and the fixed pin return spring 2116 allows the fixed pin 2115 being repositioned in the folding positioning hole 2124 when the user releases the folding switch component 30.

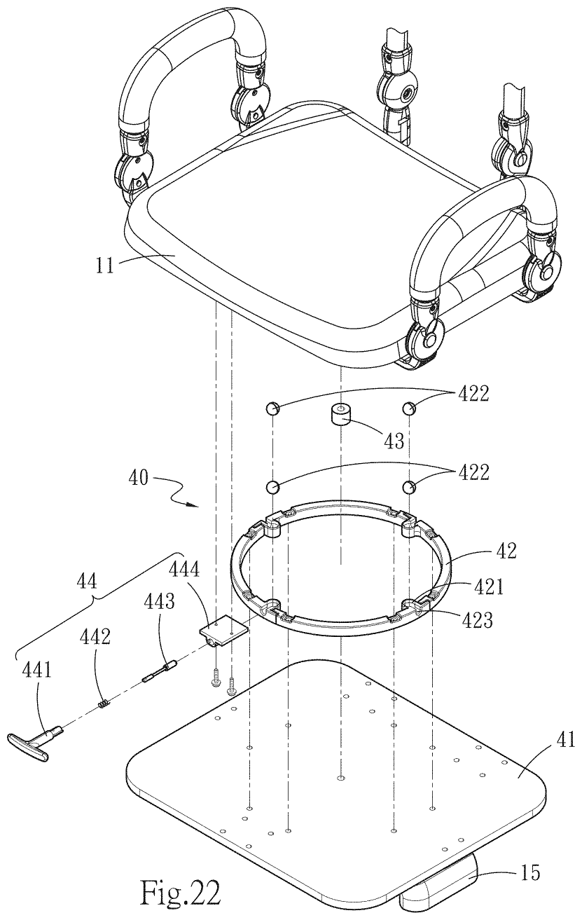

Referring to FIG. 22, it shows the foldable and displaceable bathing chair structure according to another embodiment of the present invention, and the main structural features thereof which are the same as those of the above embodiments will not be detailed. In one embodiment, the foldable and displaceable bathing chair structure further comprises a seat rotating unit 40 between the movable cushion 11 and the sliding components 14. The seat rotating unit 40 comprises a first plate body 41, a positioner 42 provided on the first plate body 41, a pivoting shaft 43 provided on the first plate body 41 and positioned in the positioner 42, and a limiting fixer 44 provided on the first plate body 41 and positioned on a periphery of the positioner 42. The pivoting shaft 43 is pivotally connected between the movable cushion 11 and the first plate body 41, so that the movable cushion 11 is rotatable around the pivoting shaft 43 as a center to adjust the direction. The positioner 42 comprises a plurality of accommodating slots 421, a plurality of ball bearings 422 and a plurality of rotary positioning holes 423. Each of the plurality of accommodating slots 421 accommodates one of the plurality of ball bearings 422, wherein the plurality of ball bearings 422 abuts the movable cushion 11 to assist the movable cushion 11 in rotation. The plurality of rotary positioning holes 423 is disposed evenly on the positioner 42. The limiting fixer 44 comprises a limit rod 441, a group of return springs 442 arranged on the limit rod 441, a group of limit rod connecting pieces 443 arranged on the limit rod 441 and sleeved in the group of return springs 442, and a limit fixing piece 444. The limit fixing piece 444 accommodates in the positioner 42 and limits the limit rod 441, the return springs 442 and the limit rod connecting pieces 443. Therefore, one end of each limit rod connecting piece 443 is inserted into one of the plurality of rotary positioning holes 423, so that the movable cushion 11 is positioned and fixed in a preset direction; and the other end of the limit rod connecting piece 443 is moved toward the other end of the rotary positioning holes 423 by the user, so that the limit rod connecting piece 443 is moved away from the plurality of rotary positioning holes 423. Further, the user releases the limit rod 441 after the movable cushion 11 is rotated to a predetermined direction, and the limit rod connecting piece 443 is inserted into the rotary positioning hole 423 by the return spring 442 correspondingly.

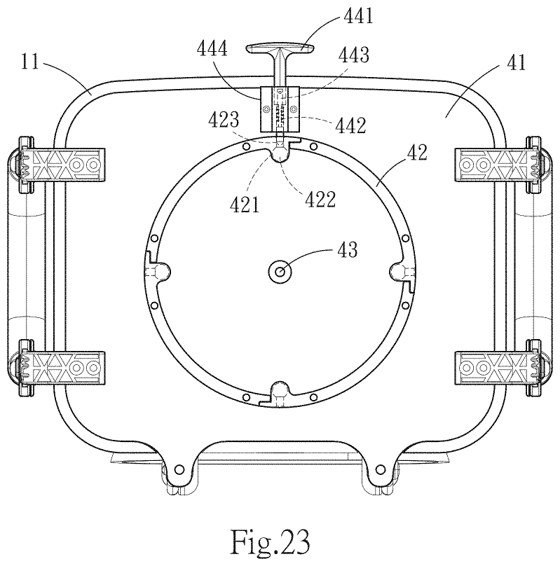

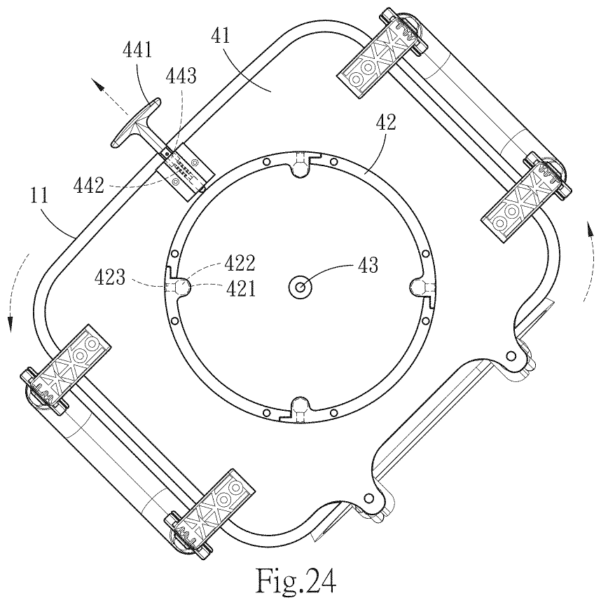

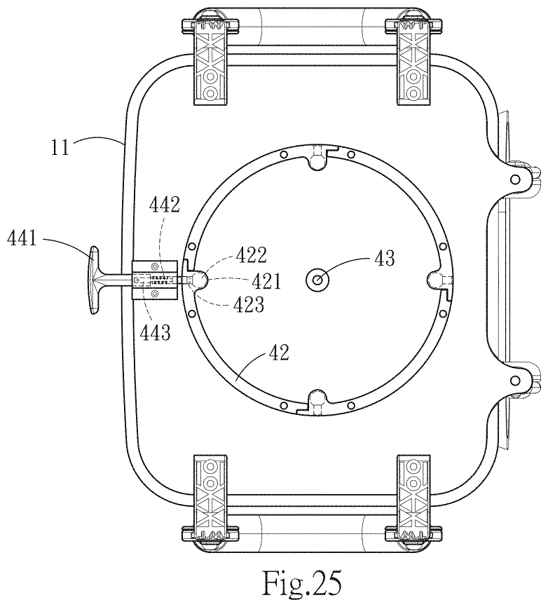

Accordingly, referring to FIG. 23 and FIG. 25, after the limit rod 441 is pulled up, the limit rod connecting piece 443 is disengaged from the plurality of rotary positioning holes 423 of the positioner 42 via the limit rod connecting piece 443 driven by the return spring 442. Thus, and the movable cushion 11 can be rotated in any direction based on requirements. That is, the movable cushion 11 is relatively rotated by the pivoting shaft 43 with respect to the positioner 42. After the movable cushion 11 is rotated to a proper position, the limit rod connecting piece 443 is fixed and positioned in the plurality of rotary positioning holes 423 of the positioner 42 by the elastic force of the return spring 442, so that the movable cushion 11 is fixed in one direction without rotating. In the present embodiment, the positioner 42 comprises four rotary positioning holes 423, which are equally arranged in four directions of the positioner 42, but are not limited thereto.

In summary, the rollers 141 of the sliding components 14 enable the movable cushion 11 to move on the cushion pipe bodies 24 in a simple and labor-saving manner, which solves the problem that the user does not move easily due to sitting on the movable cushion 11, and the cushion pipe bodies 24 are not deformed at the same time. Meanwhile, the folding switch component 30 is easily operated and slidable to control the fixed pin 2115 to be disengaged from each of the two folding positioning holes 2124, if the user wants to fold or unfold the four chair legs 22.

What is claimed is:

1. A foldable and displaceable bathing chair structure, comprising:
a seat unit comprising a movable cushion and at least two sliding components arranged below the movable cushion, wherein each of the sliding component includes at least one roller, and at least one of the sliding components includes a seat positioning piece, two sliding connecting pieces pivotally connected on the seat positioning piece, two connecting wire bodies respectively connected to one end of one of the two sliding connecting pieces, and a sliding return spring pivotally connected on the seat positioning piece; and
a seat supporting unit comprising four folding units, four chair legs, two side pipe bodies and two cushion pipe bodies, wherein each of the four folding units comprises a first connecting part connected with one of the four chair legs, a second connecting part connected with one of the two side pipe bodies and a third connecting part connected with one of the two cushion pipe bodies, and wherein each of the two cushion pipe bodies includes at least one seat positioning hole, and each of the two side pipe bodies includes a folding switch component;
wherein each of the two cushion pipe bodies is provided with one of the sliding components, the roller of each sliding component drive the movable cushion to move on the cushion pipe bodies, and the seat positioning hole provides the seat positioning piece to position and fix the movable cushion; and
wherein the folding switch components enable the chair legs connected with the first connecting parts of the folding units to be displaced relative to the cushion pipe bodies.

2. The foldable and displaceable bathing chair structure according to claim 1, wherein each of the four folding units comprises a first pivoting unit including the first connecting part and the second connecting part, and a second pivoting unit including the third connecting part; the first pivoting unit includes a first pivoting hole arranged at one end opposite to the first connecting part, and the second connecting part is positioned between the first connecting part and the first pivoting hole and protrudes outwards from a periphery of the first pivoting unit to form a pipe body for accommodating one of the two side pipe bodies; and the second pivoting unit includes a second pivoting hole where is corresponding to the first pivoting hole, and a pivoting piece penetrates through the first pivoting hole and the second pivoting hole to enable the first pivoting unit to rotate relative to the second pivoting unit.

3. The foldable and displaceable bathing chair structure according to claim 2, wherein the second connecting part of two of the four folding units comprises a fixed pin sliding slot, a fixed pin accommodated in the fixed pin sliding slot, and a fixed pin return spring; and a pivoting surface of the second pivoting unit facing the first pivoting unit comprises at least one folding positioning hole, wherein the fixed pin penetrates through the first pivoting unit and one end of the fixed pin is positioned in at least one folding positioning hole, and the other end of the fixed pin is connected with a fixed pin linkage piece to link with the folding switch component connected with the other end of the fixed pin linkage piece.

4. The foldable and displaceable bathing chair structure according to claim 3, wherein each of the two side pipe bodies further comprises a side pipe body groove and a folding switch cover body covering the side pipe body groove, the folding switch component comprises a switch abutting part accommodated in each of the two side pipe bodies to penetrate through and limit the folding switch cover body, and one end of the switch abutting part is connected with the fixed pin linkage piece.

5. The foldable and displaceable bathing chair structure according to claim 1, wherein one end of each cushion pipe body connected to the third connecting part includes a cushion pipe body positioner, and the third connecting part includes at least one cushion pipe body positioning hole, wherein the cushion pipe body positioning hole accommodates the cushion pipe body positioner.

6. The foldable and displaceable bathing chair structure according to claim 1, wherein at least one chair leg positioning hole is arranged at one end of each of the four chair legs connected to the first connecting part, and a chair leg positioner is arranged at the first connecting part correspondingly, wherein one of the chair leg positioning holes provides for accommodating the chair leg positioner therein.

7. The foldable and displaceable bathing chair structure according to claim 1, wherein one side of the seat unit includes a sliding control switch, and each sliding control switch is separately connected with the other end of one of the two sliding connecting pieces and controls the seat positioning piece pivotally connected at the sliding connecting piece to be disengaged from the seat positioning hole.

8. The foldable and displaceable bathing chair structure according to claim 1, wherein the seat unit comprises a bendable backrest component and two detachable auxiliary side grips, and the bendable backrest component comprises a backrest and at least one backrest control switch, which controls the backrest to be bent relative to the movable cushion.

9. The foldable and displaceable bathing chair structure according to claim 8, wherein the backrest control switch comprises a first positioning backrest pivoting piece with two first limiting slots, a backrest positioning piece with two backrest limiting blocks, a second positioning backrest pivoting piece with at least three second limiting slots, and a backrest control switch pivoting piece, and wherein the backrest positioning piece further includes a backrest positioning chamber for accommodating a backrest return spring, and the two backrest limiting blocks are accommodated in the two first limiting slots and two of the second limiting slots.

10. The foldable and displaceable bathing chair structure according to claim 1, wherein a seat rotating unit is provided between the movable cushion and the sliding components, the seat rotating unit comprising: a first plate body, a positioner arranged on the first plate body, a pivoting shaft arranged on the first plate body and positioned in the positioner, and a limiting fixer arranged on the first plate body and positioned on a periphery of the positioner, wherein the pivoting shaft is pivotally connected between the movable cushion and the first plate body, and the positioner includes a plurality of accommodating slots, a plurality of ball bearings and a plurality of rotary positioning holes; each of the plurality of accommodating slots accommodates one of the ball bearings, the plurality of ball bearings abuts the movable cushion, and the plurality of rotary positioning holes are arranged on the positioner; and the limiting fixer includes a limit rod, a group of return springs arranged on the limit rod, a group of limit rod connecting pieces arranged on the limit rod and sleeved in the group of return spring, and a limit fixing piece, wherein the limit fixing piece accommodates in the positioner and limits the limit rod, the return spring and the limit rod connecting piece, and each limit rod connecting piece is inserted into each rotary positioning hole.
